(19) United States
(12) Patent Application Publication
(10) Pub. No.: US 2026/0323782 A1
(43) Pub. Date: Oct. 15, 2026

(54) FOOD WARMING PLATE

(71) Applicants: Chongqing Yingnuo Changqing Technology Co., Ltd., Chongqing (CN); Foshan Nobike Electric Appliance Co., Ltd., Foshan (CN)

(72) Inventors: Zhongmei Chen, Foshan (CN); Xin Chen, Foshan (CN)

(21) Appl. No.: 19/464,569

(22) Filed: Jan. 29, 2026

(30) Foreign Application Priority Data
Mar. 11, 2025 (CN) 2025204227075

(51) Int. Cl. H05B 3/68; H05B 1/02

(52) U.S. Cl. CPC H05B 3/68; H05B 1/0266; H05B 2203/005

(57) ABSTRACT

Disclosed is a food warming plate. The food warming plate includes a food warming plate unit which includes a control box, a plate body and heating wires. A control board is arranged in the control box. The plate body includes a first plate body and a second plate body connected to opposite sides of the control box respectively. Grooves are formed on backs of both the first plate body and the second plate body. The heating wires are received in the grooves and electrically connected to the control board, and the control board is configured to control the power supply of the heating wires.

### REFERENCE TO RELATED APPLICATIONS

The present application claims the priority of the Chinese patent application No. 202521517556.8, filed on Jul. 21, 2025. The disclosure of the aforementioned application is incorporated in this application by reference in its entirety.

### TECHNICAL FIELD

The present application relates to a field of tableware and kitchenware, and in particular to a food warming plate.

### BACKGROUND

No matter which method is used to cook food, pan-frying, stir-frying, deep frying, braising, steaming or stewing, food with an appropriate temperature is the primary condition for dining. As the pace of life accelerates and lifestyles change, it is difficult for people to fix their dining time. Therefore, it is necessary to place the cooked food on a food warming plate for heat preservation, so as to meet people's diverse dining needs, reduce meal waiting time, and avoid additional loss resulted from repeated heating of food.

However, due to the limitations of the production process, the food warming plates on the market have limited sizes and limited heating areas. Moreover, each plate is heated integrally at a uniform temperature, and does not support zonal division for independent heating with distinct temperatures per zone. Those plates are not suitable for the different heat preservation needs of different foods, and each plate being heated uniformly leads to mismatching between heat distribution and demand, resulting in low energy efficiency.

At the same time, the existing food warming plates do not support parallel expansion with multiple units, and are not adaptable to tables of varying sizes and scenarios involving different numbers of diners.

### SUMMARY

The present application is to provide a food warming plate to overcome one or more deficiencies existing in the related art.

A food warming plate includes:
a food warming plate unit, including:
a control box having a control board inside;
a plate body, including:
a first plate body connected with a side of the control box; and
a second plate body connected with an opposite side of the control box, wherein grooves are formed on backs of the first plate body and the second plate body; and
heating wires received in the grooves and electrically connected with the control board, wherein the control board is configured to control power supply of the heating wires.

In one embodiment, the grooves include:
a first groove formed on the first plate body;
a second groove formed on the first plate body; and
a third groove formed on the second plate body,
the heating wires include:
a first heating wire received in the first groove;
a second heating wire received in the second groove; and
a third heating wire received in the third groove,
the first plate body and the second plate body have the same size or different sizes.

In one embodiment, the grooves further include a fourth groove formed on the second plate body, and the heating wires further include a fourth heating wire received in the fourth groove.

In one embodiment, the control box includes:
a bottom box including two opposite ends provided with mounting cylinders,
each of the first plate body and the second plate body includes:
an edge part formed with mounting holes, received in the control box and sleeved on the mounting cylinders through the mounting holes.

In one embodiment, the control box further includes:
an upper cover, including:
two opposite sides formed with mounting posts matching with the mounting cylinders and fixed in the mounting cylinders one to one,
the mounting cylinders are formed with through holes configured for screws to pass through and screw into the mounting posts to fix the control box with the first plate body and the second plate body.

In one embodiment, the control box includes:
an end provided with an input interface; and
another end provided with an output interface,
the food warming plate further includes:
another food warming plate unit; and
an electrical connector including:
a first end configured to be plugged into the input interface of the another food warming plate unit; and
an opposite second end configured to be plugged into the output interface of the food warming plate unit to electrically connect the food warming plate unit and the another food warming plate unit in parallel and power the another food warming plate unit through the food warming plate unit.

In one embodiment, a microswitch is arranged in the control box to correspond to the output interface, the second end of the electrical connector is formed with a pin to press the microswitch to electrically connect the input interface with the output interface of the food warming plate unit, after the electrical connector is plugged into the output interface.

In one embodiment, the first plate body includes:
an edge part received in the control box and formed with a wiring groove, the wiring groove including:
a connecting groove connecting the first groove and the second groove;
a first zone-dividing groove connecting the first groove; and
a second zone-dividing groove connecting the second groove.

In one embodiment, the first heating wire and the second heating wire are not connected to each other, an end of the first heating wire adjacent to the second heating wire is extended into the control box through the first zone-dividing groove, an end of the second heating wire adjacent to the first heating wire is extended into the control box through the second zone-dividing groove, and the first heating wire and the second heating wire are configured to form two mutually independent heating zones on the first plate body under control of the control board.

In one embodiment, the first heating wire and the second heating wire form different parts of a heating wire, the first heating wire and the second heating wire are connected in the connecting groove, and the first heating wire and the second heating wire are configured to form a single heating zone on the first plate body under control of the control board.

In one embodiment, the second plate body includes:
an edge part received in the control box and formed with a wiring groove, the wiring groove including:
a connecting groove connecting the third groove and the fourth groove;
a first zone-dividing groove connecting the third groove; and
a second zone-dividing groove connecting the fourth groove.

In one embodiment, the third heating wire and the fourth heating wire are not connected to each other, an end of the third heating wire adjacent to the fourth heating wire is extended into the control box through the first zone-dividing groove, an end of the fourth heating wire adjacent to the third heating wire is extended into the control box through the second zone-dividing groove, and the third heating wire and the fourth heating wire are configured to form two mutually independent heating zones on the second plate body under control of the control board.

In one embodiment, the third heating wire and the fourth heating wire form different parts of a heating wire, and the third heating wire and the fourth heating wire are connected in the connecting groove and configured to form a single heating zone on the second plate body under control of the control board.

In one embodiment, the first groove and the second groove are both S-shaped and distributed on the back of the first plate body in a zoned manner.

In one embodiment, the third groove and the fourth groove are both S-shaped and distributed on the back of the second plate body in a zoned manner.

In one embodiment, the connecting groove is arc-shaped.

In one embodiment, the backs of the first plate body and the second plate body are formed with a plurality of uniformly distributed first bumps and a plurality of uniformly distributed second bumps, a bottom area of each of the plurality of first bumps is larger than a bottom area of each of the plurality of second bumps; and lower edges of the plurality of first bumps are flush with lower edges of the plurality of second bumps.

In one embodiment, both the first plate body and the second plate body are flexible plates, or both the first plate body and the second plate body are silicone plates.

The food warming plate provided by embodiments of the present application has at least one of the beneficial effects given below.

The food warming plate provided by the embodiments of the present application is provided with a plurality of heating zones, which can realize heating at different temperatures in different zones, and the food heat preservation is more flexible. One control box is used to connect a plurality of food warming plates with double temperature zones, multiple temperature zones or a single temperature zone, thereby meeting the use requirements of different occasions and different numbers of people. A plurality of large and uniformly distributed bumps are provided, which makes the food warming plate more stable and not easy to be split or deformed due to force applied at a certain point, thereby improving the user experience.

A microswitch is provided beside the output interface, the power is supplied only when the electrical connector is inserted and press the microswitch. Consequently, even if the user opens the cover and exposes the output interface, the output interface remain safe to touch. Thus, the microswitch plays a safety protection role and improves the safety of the food warming plate during operation.

### BRIEF DESCRIPTION OF DRAWINGS

To more clearly illustrate the embodiments of the present application or the technical schemes in the related art, the drawings accompanying the description of the embodiments or the related art will be briefly introduced below. Obviously, the drawings in the following description are only exemplary. For those of ordinary skill in the art, other drawings can be obtained based on those drawings without creative work.

The structures, proportions, sizes, etc. shown in this specification are only used to match the content of the specification for the understanding and reading of those familiar with this technology, and are not intended to limit the applicable conditions of the present application, thus, they have no technical substantive significance. Any structural modification, change in proportional relationships, or dimensional adjustment shall still fall within the scope contemplated by the technical content disclosed herein, provided that such alterations do not impair the efficacy and objectives achievable by the present application.

FIG. 1 is a schematic three-dimensional view of a food warming plate according to a first embodiment of the present application.

FIG. 2 is a schematic front view of a food warming plate according to a second embodiment of the present application.

FIG. 3 is a schematic front view of a food warming plate according to a third embodiment of the present application.

FIG. 4 is a back view of the food warming plate of FIG. 1.

FIG. 5 is an enlarged view of part A of the food warming plate of FIG. 4.

FIG. 6 is an enlarged view of part B of the food warming plate of FIG. 4.

FIG. 7 is an exploded view of a control box of the food warming plate of FIG. 1.

FIG. 8 is a structural view of a plate body of the food warming plate of FIG. 1.

FIG. 9 shows heating wires of the food warming plate of FIG. 1.

FIG. 10 is a partial cross-sectional view of the food warming plate of FIG. 1.

FIG. 11 shows two types of electrical connectors that can be equipped in the food warming plate of FIG. 1.

FIG. 12 shows a food warming plate including a plurality of food warming plate units.

FIG. 13 shows a back view of the food warming plate of FIG. 2.

FIG. 14 shows a back view of the food warming plate of FIG. 3.

FIG. 15 shows a schematic circuit block diagram of the food warming plate of FIG. 1, in which a first heating wire is connected in series with a second heating wire or a third heating wire is connected in series with a fourth heating wire.

FIG. 16 shows another schematic circuit block diagram of the food warming plate of FIG. 1, in which each heating wire is independently controlled.

### DETAILED DESCRIPTION

The specific embodiments of the present application will be further described below with reference to the accompanying drawings. It should be noted here that the descriptions of these embodiments are used only to help understand the present application, but do not constitute a limitation to the present application. In addition, the technical features involved in the various embodiments of the present application described below can be combined with each other as long as they do not conflict with each other.

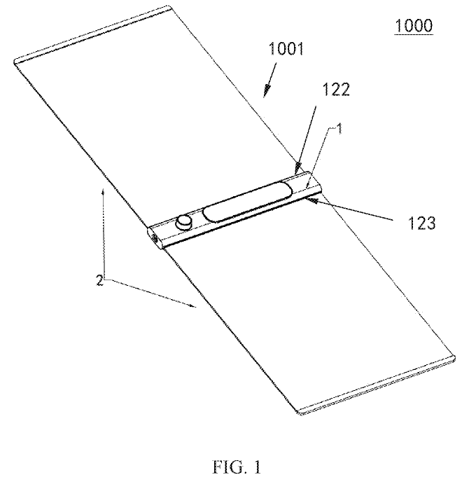

Referring to FIGS. 1-3, a food warming plate 1000 provided by the embodiments of the present application includes a food warming plate unit 1001. The food warming plate unit 1001 includes a control box 1, a plate body 2 and heating wires 3. A control board is arranged in the control box 1. The plate body 2 includes a first plate body 21 and a second plate body 22. Opposite sides of the control box 1 are connected with the first plate body 21 and the second plate body 22 correspondingly. Grooves are formed on backs of the first plate body 21 and the second plate body 22. The heating wires 3 are arranged in the grooves and electrically connected with the control board. The control board is configured to control the power supply of the heating wires 3.

In one embodiment, as shown in FIG. 14, the grooves include a first groove and a second groove formed on the first plate body 21, and a third groove 221 formed on the second plate body 22. The heating wires 3 include a first heating wire, a second heating wire and a third heating wire 33. The first heating wire is received in the first groove, the second heating wire is received in the second groove, and the third heating wire 33 is received in the third groove 221.

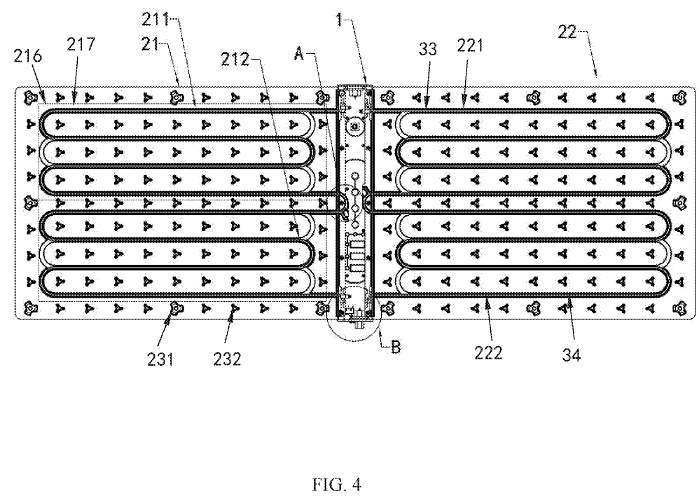

In one embodiment, as shown in FIG. 4, the grooves further include a fourth groove 222 formed on the second plate body 22. The heating wires 3 further include a fourth heating wire 34, which is received in the fourth groove 222.

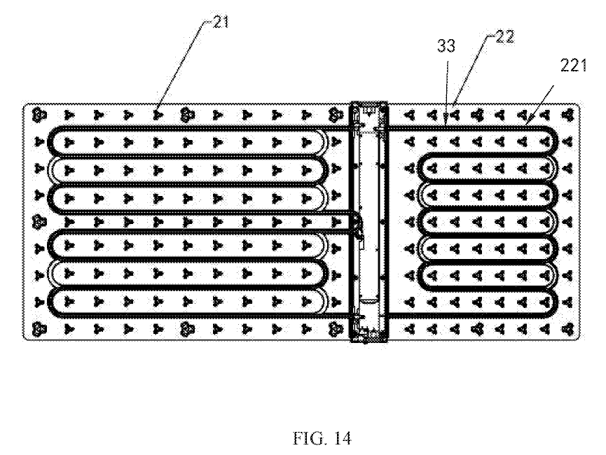

In one embodiment, as shown in FIG. 13, the grooves include only the first groove on the first plate body 21 and the third groove 221 on the second plate body 22. The heating wires 3 include only the first heating wire and the third heating wire 33. The first heating wire is received in the first groove, and the third heating wire 33 is received in the third groove 221.

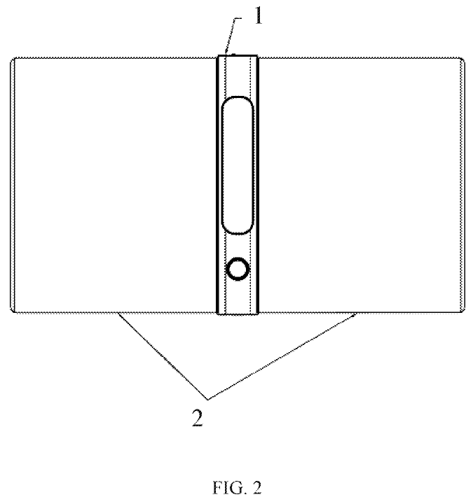

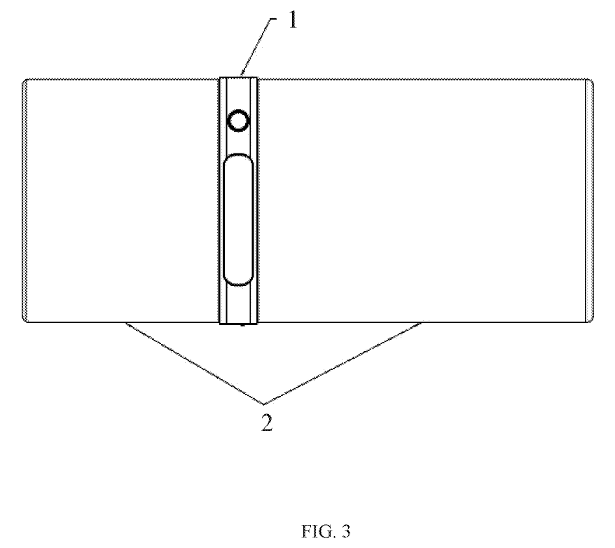

In some embodiments, as illustrated in FIGS. 1-2, the first plate body 21 and the second plate body 22 are of the same size. In other embodiments, as shown in FIG. 3, the first plate body 21 and the second plate body 22 are of different sizes, and no limitation is imposed herein.

Several embodiments of the present application are introduced below.

### First Embodiment

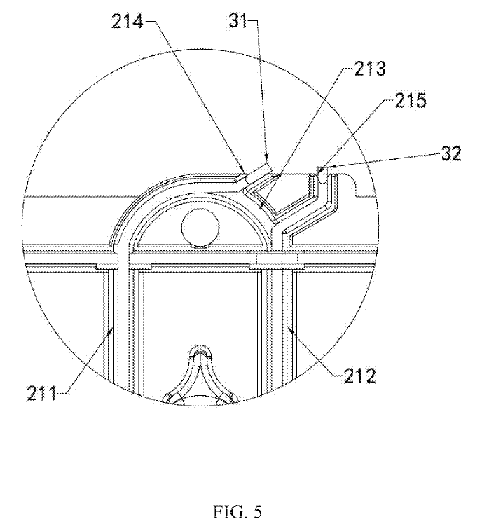

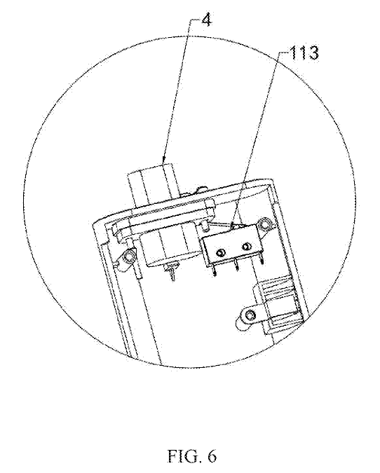

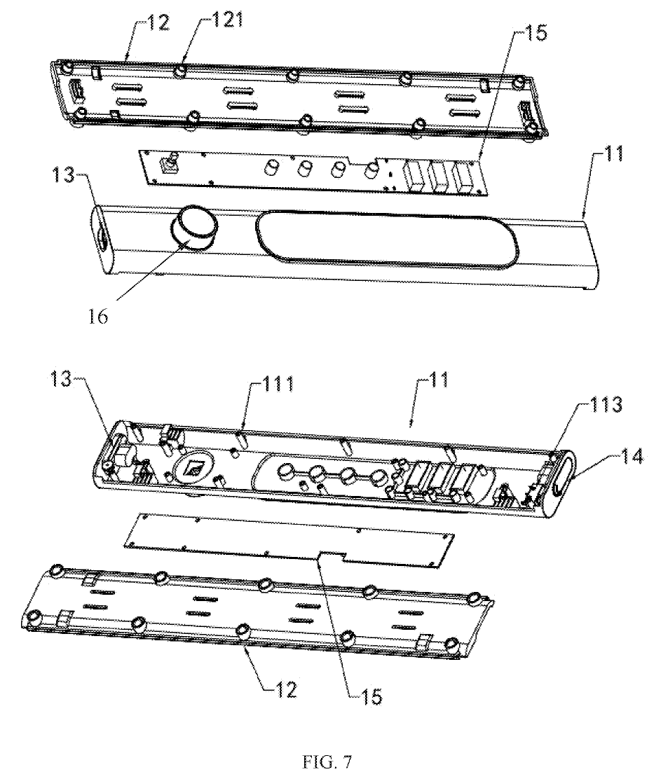

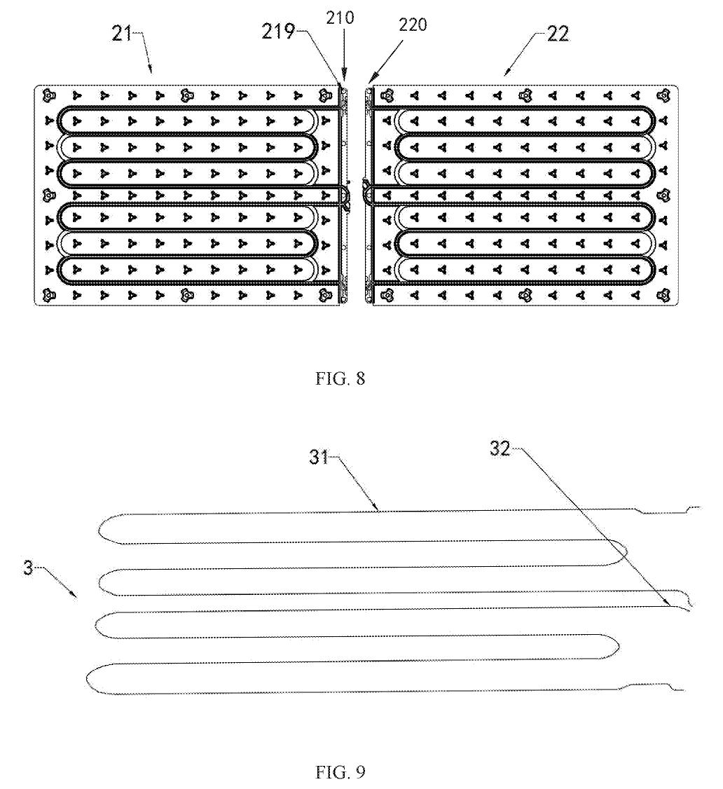

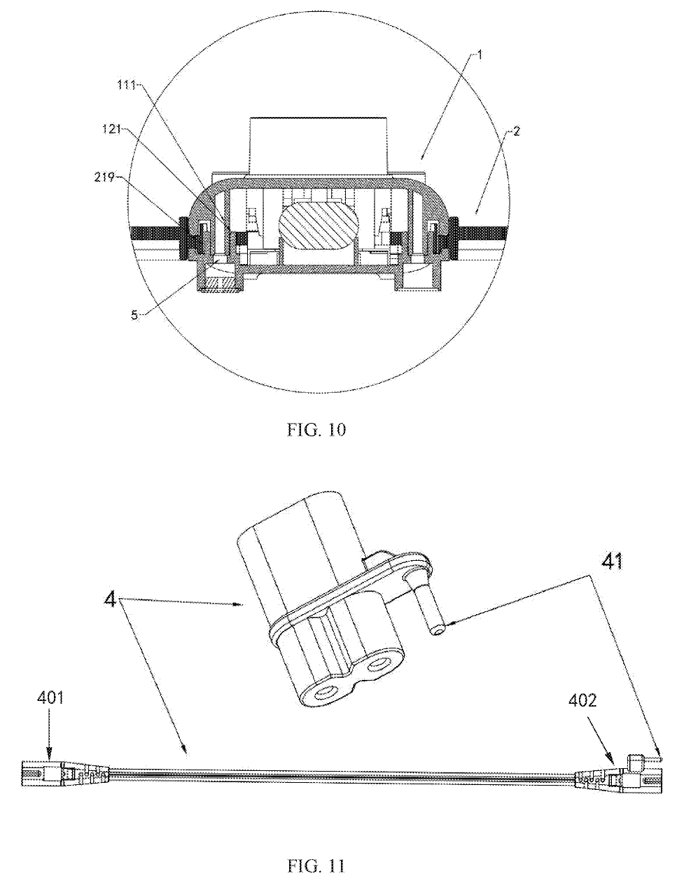

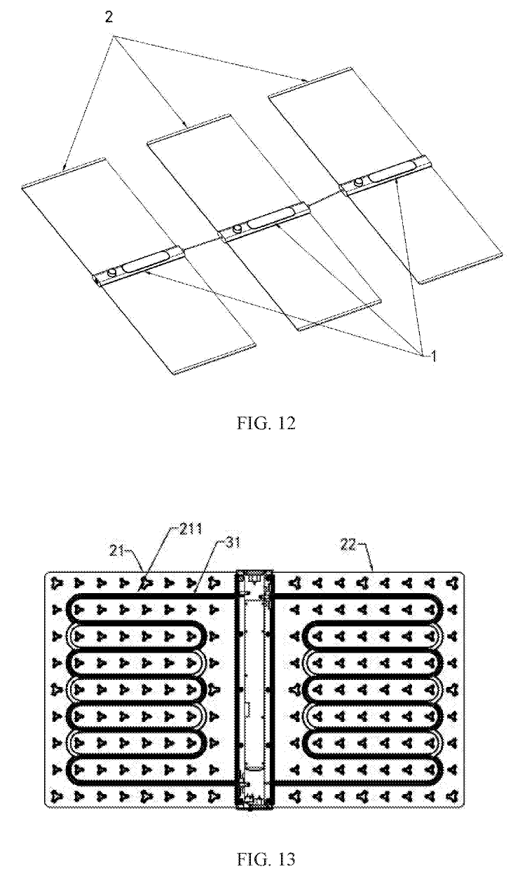

Referring to FIGS. 1 and FIG. 4-12, a first embodiment of the present application discloses a food warming plate 1000. The food warming plate 1000 includes one or more food warming plate units 1001. Each food warming plate unit 1001 includes a control box 1, a plate body 2 and heating wires 3. A control board 15 is arranged in the control box 1. In this embodiment, the plate body 2 includes a first plate body 21 and a second plate body 22. Opposite sides 122 and 123 of the control box 1 are connected with the first plate body 21 and the second plate body 22 correspondingly. Grooves are formed on backs of the first plate body 21 and the second plate body 22. The heating wires 3 are received in the grooves and form heating plates with the first plate body 21 and the second plate body 22. The heating wires 3 are electrically connected with the control board 15.

The control box 1 includes a bottom box 12. Mounting cylinders 121 are respectively arranged on opposite sides of the bottom box 12. Mounting holes 219 are formed on an edge part 210 of the first plate body 21 and an edge part 220 of the second plate body 22. An inner diameter of each mounting hole 219 is larger than an outer diameter of a corresponding mounting cylinder 121 and each mounting hole 219 matches with the corresponding mounting cylinder 121. The edge part 210 of the first plate body 21 and the edge part 220 of the second plate body 22 are received in the control box 1 and sleeved on the corresponding mounting cylinders 121 through the corresponding mounting holes 219. The control box 1 further includes an upper cover 11. Mounting posts 111 are distributed on opposite sides of the upper cover 11. An outer diameter of each mounting post 111 is smaller than an inner diameter of a corresponding mounting cylinder 121 and each mounting post 111 matches with the corresponding mounting cylinder 121. Each mounting post 111 is fixed in the corresponding mounting cylinder 121. A through hole 5 is formed at a bottom of each mounting cylinder 121. Screws are screwed into the mounting posts 111 through the through holes 5 to fix the control box 1 with the first plate body 21 and the second plate body 22. The control box 1 is located in the middle of each food warming plate unit 1001, and heating plates are assembled on the left and right sides of the control box 1, so that an overall heating area is expanded. Moreover, mounting holes 219 are formed on the plate body 2, and the plate body 2 can be fixed through the mounting posts 111 and the mounting cylinders 121 in the control box 1 and screws, thus the installation of the plate body 2 is simple and convenient. In addition, since the control box 1 can be adapted to plate bodies 2 with different sizes and specifications, a variety of food warming plates 1000 can be produced based on the control boxes 1 of the same type.

In a condition that two or more food warming plate units 1001 are included in one food warming plate 1000, every two adjacent food warming plate units 1001 are connected through an electrical connector 4. An input interface 13 and an output interface 14 are distributed at two opposite ends of the control box 1 of each food warming plate unit 1001. A first end 401 of the electrical connector 4 is configured for being plugged with the input interface 13 of the control box 1 of one of the food warming plate units 1001, and a second end 402 of the electrical connector 4 is configured for being plugged with the output interface 14 of the control box 1 of another food warming plate unit 1001. A pin 41 is formed at the second end 402 of the electrical connector 4. After the second end 402 of the electrical connector 4 is plugged into the output interface 14 of one of the food warming plate units 1001 and the first end 401 is plugged into the input interface 13 of another food warming plate unit 1001, the two food warming plate units 1001 are connected in parallel. Through one or more such electrical connectors 4, two or more food warming plate units 1001 can be electrically connected in sequence. The food warming plate 1000 is thus adapted to tables of different sizes and scenarios of different numbers of diners. In this embodiment, different parts of the electrical connector 4 are integrated into one body. In another embodiment, the electrical connector 4 includes three mutually separable parts, that is, the first end 401 and the second end 402 are connected through a wire, the first end 401 and the wire are connected in a pluggable manner, and the second end 402 and the wire are also connected in a pluggable manner. In addition, the electrical connector 4 can also adopt the type shown in the upper part of FIG. 11. The control board 15 of each food warming plate unit 1001 includes a control component for controlling the food warming plate unit 1001 it belongs to. Each food warming plate unit 1001 includes a control box 1, a plate body 2 and heating wires 3. Different temperature zones can be set on a single heating plate, which is suitable for the different heat preservation requirements of different foods. The parallel expansion of multiple food warming plate units 1001 is also supported, which caters to the requirements of tables of varying sizes and different numbers of diners.

A first groove 211 and a second groove 212 are formed on the back of the first plate body 21. A wiring groove is formed on the edge part 210 of the first plate body 21. The wiring groove includes a connecting groove 213, a first zone-dividing groove 214 and a second zone-dividing groove 215. The connecting groove 213 is connected with an end of the first groove 211 and an end of the second groove 212. The first zone-dividing groove 214 is connected with the first groove 211 and the second zone-dividing groove 215 is connected with the second groove 212. The first zone-dividing groove 214 and the second zone-dividing groove 215 are not connected with each other. The heating wires 3 include a first heating wire 31 and a second heating wire 32. The first groove 211 is coated with coating compound, and the first heating wire 31 is embedded in the coating compound. The coating compound can be coating rubber such as silicone rubber. The second groove 212 is also coated with coating compound, and the second heating wire 32 is embedded in the coating compound. Both the first groove 211 and the second groove 212 are S-shaped. The first groove 211 and the second groove 212 are distributed on the back of the first plate body 21 in a left-right or up-down zoned manner, that is, the first plate body 21 is divided into two zones along the left-right or up-down direction, the first groove 211 is located in one of the zones, and the second groove 212 is located in the other of the zones. Both the first groove 211 and the second groove 212 are provided with limiting grooves and limiting buckles. A plurality of first bumps 231 and a plurality of second bumps 232 are further arranged on the back of the plate body 2. A bottom area of each first bump 231 is larger than that of each second bump 232, and lower edges of the first bumps 231 are flush with those of the second bumps 232.

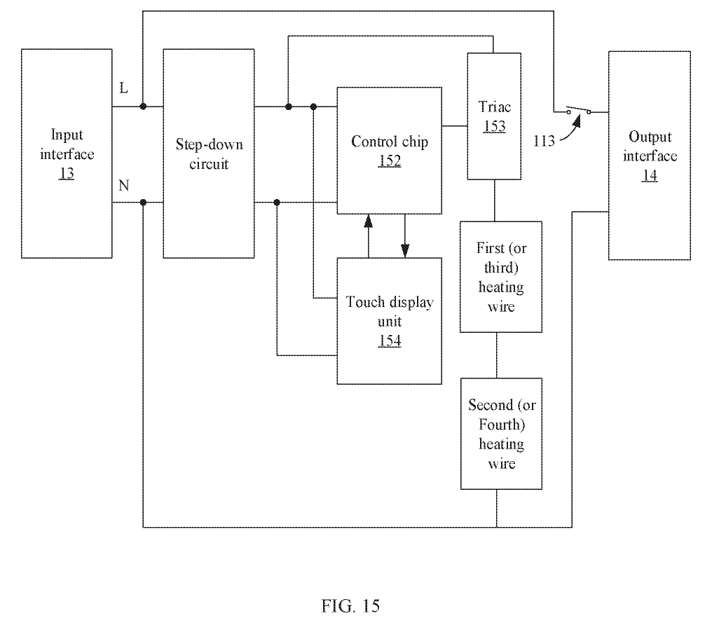

Since the first groove 211 and the second groove 212 are connected or communicated through the connecting groove 213, referring also to FIG. 15, in one embodiment, the first heating wire 31 and the second heating wire 32 are actually different parts of a heating wire, and the first heating wire 31 and the second heating wire 32 are connected in the connecting groove 213, that is, the first heating wire 31 is connected in series with the second heating wire. The control component (such as a control chip 152 and a triac (Triode for Alternating Current) 153 in FIG. 15) on the control board 15 controls the first heating wire 31 and the second heating wire 32 to generate heat together, so as to form a large heating zone 216 on the first plate body 21. The user selects the large heating zone 216 through a touch display unit 154 and then sends a control command for adjusting a temperature to the control chip 152 by rotating the knob 16, so that the large heating zone 216 reaches the temperature desired by the user.

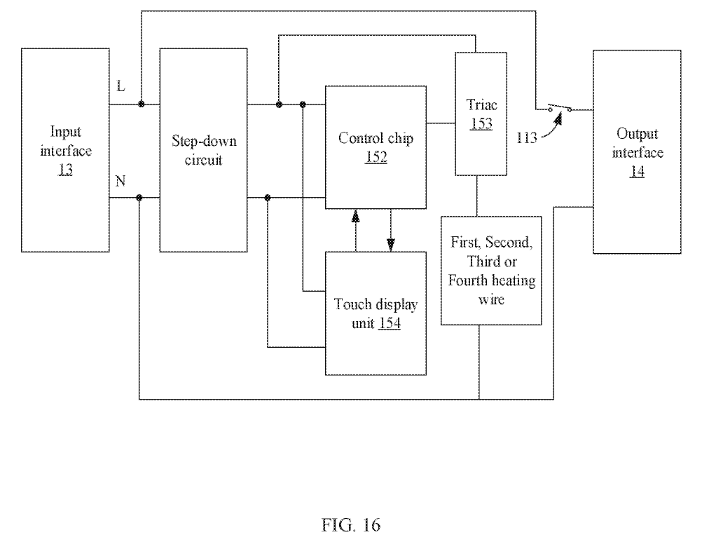

It can be understood that referring to FIG. 16, in another embodiment, an end of the first heating wire 31 adjacent to the second heating wire 32 enters the control box 1 through the first zone-dividing groove 214, and an end of the second heating wire 32 adjacent to the first heating wire 31 enters the control box 1 through the second zone-dividing groove 215. The first heating wire 31 and the second heating wire 32 are not connected in series, but are independently controlled by the control component, thus, two mutually independent heating zones 217 on the first plate body 21 are formed. The user selects one of the heating zones 217 through the touch display unit 154 and then adjusts the power of the heating wire corresponding to the heating zone 217 through the knob 16, so as to change the temperature of the heating zone 217. In this way, the first heating wire 31 and the second heating wire 32 can be controlled to generate heat independently by the control component. The control component can control only the first heating wire 31 to generate heat, or only the second heating wire 32 to generate heat. Furthermore, the control component can control both the first heating wire 31 and the second heating wire 32 to generate heat at the same power, so that different zones of the first plate body 21 have the same temperature. The control component can also control the first heating wire 31 and the second heating wire 32 to generate heat at different powers, so that different zones of the first plate body 21 have different temperatures.

In this embodiment, the arrangement of the grooves and the wiring grooves on the back of the second plate body 22 is the same as that of the first plate body 21. In detail, a third groove 221 and a fourth groove 222 are formed on the back of the second plate body 22. Both the third groove 221 and the fourth groove 222 are S-shaped and distributed on the second plate body 22 in a left-right or up-down zoned manner. A third heating wire 33 is accommodated in the third groove 221, and a fourth heating wire 34 is accommodated in the fourth groove 222. In one embodiment, the third heating wire 33 and the fourth heating wire 34 are connected in the connecting groove of the wiring groove to form different parts of a heating wire, so that a large heating zone is formed on the second plate body 22. In another embodiment, ends of the third heating wire 33 and the fourth heating wire 34 adjacent to each other are not connected, but enter the control box 1 through the respective corresponding zone-dividing grooves of the wiring groove. As a result, two heating zones are formed on the second plate body 22. The connection modes and control modes of the third heating wire 33 and the fourth heating wire 34 in the above two cases can refer to the connection modes and control modes of the first heating wire 33 and the second heating wire 32 described above. The structure of the wiring groove on the second plate body 22 is the same as or similar to that of the wiring groove on the first plate body 21, and also includes a connecting groove, a first zone-dividing groove and a second zone-dividing groove, which will not be repeated here.

In FIGS. 15 and 16, one end of the triac 153 is connected behind the step-down circuit. In other embodiments, this end of the triac 153 can be connected in front of the step-down circuit, that is, this end of the triac 153 is connected between the step-down circuit and the input interface 13.

In this embodiment, both the first plate body 21 and the second plate body 22 are provided with two heating zones 217, and different zones can be heated at different temperatures, which makes food heat preservation more flexible. The first groove 211, the second groove 212, the third groove 221, and the fourth groove 222 each feature an inverted T-shaped cross-section. This structural design prevents obstruction by internal protrusions, enables the coating compound to fully encapsulate the heating wires 3, and thereby enhances the operability and safety of the food warming plate 1000. Limiting grooves and limiting buckles are provided at junctions of the first groove 211 with the first zone-dividing groove 214, the second groove 212 with the second zone-dividing groove 215, and the third and fourth grooves 221 and 222 with their respective zone-dividing grooves. The limiting grooves and limiting buckles can securely fix the first heating wire 31, the second heating wire 32, the third heating wire 33, and the fourth heating wire 34, preventing them from falling off easily. The first bumps 231 and the second bumps 232 are uniformly and densely distributed, and their lower edges are flush with each other. Therefore, when a force is applied to a certain point of the plate body 2, the plate body 2 is not easy to split or deform and has a stable structure.

In this embodiment, both the first plate body 21 and the second plate body 22 are flexible plates, for example, both the first plate body 21 and the second plate body 22 are silicone plates.

The upper cover 11 is further provided with a microswitch 113 and a cover. The microswitch 113 is positioned corresponding to the output interface 14 and located on a power supply path from the input interface 13 to the output interface 14. After the electrical connector 4 is plugged into the output interface 14, a pin 41 presses an elastic piece of the microswitch 113. The bottom box 12 is further provided with foot pads. Lower edges of the foot pads, the first bumps 231 and the second bumps 232 are flush. When only one food warming plate unit 1001 is used, the output interface 14 of the food warming plate unit 1001 is covered by the cover, which is safe and aesthetic. The microswitch 113 is arranged beside the output interface 14 and located on the power supply path from the input interface 13 to the output interface 14. After the electrical connector 4 is plugged into the output interface 14 and presses the microswitch 113, the microswitch 113 closes the power supply path from the input interface 13 to the output interface 14, thereby enabling the output interface 14 to supply power. Conversely, if the electrical connector 4 is disconnected, the output interface 14 is de-energized. Consequently, even if the user opens the cover and exposes the output interface 14, the output interface 14 remains safe to touch. Thus, the microswitch 113 plays a safety protection role and improves the safety of the food warming plate 1000 during operation.

### Second Embodiment

Referring to FIG. 13, the second embodiment is carried out based on the first embodiment. In the second embodiment, the plate body 2 of the food warming plate 1000 is redesigned to reduce its size and heating modes, so as to save energy consumption for scenarios involving small-sizes tables and small numbers of diners. In this embodiment, the plate body 2 includes a first plate body 21 and a second plate body 22. Both the first plate body 21 and the second plate body 22 are flexible plates, for example, both the first plate body 21 and the second plate body 22 are silicone plates. Compared with the first embodiment, the first plate body 21 is provided with only a first groove 211 and lacks a second groove, and the second plate body 22 is provided with only a third groove 221 and lacks a fourth groove. The first groove 211 is S-shaped and located on the back of the first plate body 21, and the third groove 221 is S-shaped and located on the back of the second plate body 22. A first heating wire 31 is received in the first groove 211 of the first plate body 21, and a third heating wire 33 is received in the third groove 221 of the second plate body 22. The first plate body 21 and the second plate body 22 have no wiring grooves. A plurality of first bumps 231 and a plurality of second bumps 232 are also provided on the backs of the first plate body 21 and the second plate body 22. A bottom area of each first bump 231 is larger than that of each second bump 232. Lower edges of the first bump 231 and the second bump 232 are flush with each other. Both the first groove 211 and the third groove 221 are filled with coating compound, and the first heating wire 31 and the third heating wire 33 are embedded in the coating compound. In this way, each of the first plate body 21 and the second plate body 22 forms only a single heating zone, rather than a plurality of heating zones.

The structures and functions of a control box 1, the first heating wire 31, the third heating wire 33 and an electrical connector 4 of each food warming plate unit 1001 of the food warming plate unit 1000 of the second embodiment can make reference to the description of the first embodiment, which will not be repeated here.

### Third Embodiment

Referring to FIG. 14, the third embodiment is implemented based on the first and second embodiments. In the third embodiment, the plate body 2 of the food warming plate 1000 is redesigned to provide a more flexible heat preservation mode and adapt to more diverse use occasions and more diverse personnel scales. In this embodiment, the plate body 2 includes a first plate body 21 and a second plate body 22. Both the first plate body 21 and the second plate body 22 are flexible plates, for example, both the first plate body 21 and the second plate body 22 are silicone plates. The first plate body 21 has the same structure as the first plate body 21 in the first embodiment, that is, the first plate body 21 in the third embodiment is provided with more than one heating zones for zoned heating. The second plate body 22 has the same structure as the second plate body 22 in the second embodiment, that is, the second plate body 22 in the third embodiment is provided with a single heating zone.

The structures and functions of a control box 1, a first heating wire 31, a second heating wire 32 and an electrical connector 4 can make reference to the description of the first embodiment, and the structure and function of a third heating wire 33 can make reference to the description of the second embodiment, which will not be repeated here.

It can be understood that in some embodiments, two or more wiring grooves are arranged on the edge part 210 of the first plate body 21, and more than two heating zones 217 are formed on the first plate body 21 by utilizing a corresponding number of heating wires 3. Similarly, the number of wiring grooves on the second plate body 22 can be increased, and more than two heating zones can be formed on the second plate body 22 by utilizing a corresponding number of heating wires 3.

The embodiments of the present application have been described in detail above with reference to the accompanying drawings, but the present application is not limited to the described embodiments. For those skilled in the art, without departing from the principle and spirit of the present application, various changes, modifications, substitutions and variations can be made to these embodiments, which should be included in the claimed scope of the present application.

1. A food warming plate, comprising:
a food warming plate unit, comprising:
a control box having a control board inside;
a plate body, comprising:
a first plate body connected with a side of the control box; and
a second plate body connected with an opposite side of the control box, wherein grooves are formed on backs of the first plate body and the second plate body; and
heating wires received in the grooves and electrically connected with the control board, wherein the control board is configured to control power supply of the heating wires.

2. The food warming plate according to claim 1, wherein the grooves comprise:
a first groove formed on the first plate body;
a second groove formed on the first plate body; and
a third groove formed on the second plate body,
the heating wires comprise:
a first heating wire received in the first groove;
a second heating wire received in the second groove; and
a third heating wire received in the third groove,
the first plate body and the second plate body have the same size or different sizes.

3. The food warming plate according to claim 2, wherein the grooves further comprise a fourth groove formed on the second plate body, and the heating wires further comprise a fourth heating wire received in the fourth groove.

4. The food warming plate according to claim 3, wherein,
the control box comprises:
a bottom box comprising two opposite ends provided with mounting cylinders,
each of the first plate body and the second plate body comprises:
an edge part formed with mounting holes, received in the control box and sleeved on the mounting cylinders through the mounting holes.

5. The food warming plate according to claim 4, wherein,
the control box further comprises:
an upper cover, comprising:
two opposite sides formed with mounting posts matching with the mounting cylinders and fixed in the mounting cylinders one to one,
the mounting cylinders are formed with through holes configured for screws to pass through and screw into the mounting posts to fix the control box with the first plate body and the second plate body.

6. The food warming plate according to claim 1, wherein,
the control box comprises:
an end provided with an input interface; and
another end provided with an output interface,
the food warming plate further comprises:
another food warming plate unit; and
an electrical connector comprising:
a first end configured to be plugged into the input interface of the another food warming plate unit; and
an opposite second end configured to be plugged into the output interface of the food warming plate unit to electrically connect the food warming plate unit and the another food warming plate unit in parallel and power the another food warming plate unit through the food warming plate unit.

7. The food warming plate according to claim 6, wherein a microswitch is arranged in the control box to correspond to the output interface, the second end of the electrical connector is formed with a pin to press the microswitch to electrically connect the input interface with the output interface of the food warming plate unit, after the electrical connector is plugged into the output interface.

8. The food warming plate according to claim 2, wherein the first plate body comprises:
an edge part received in the control box and formed with a wiring groove, the wiring groove comprising:
a connecting groove connecting the first groove and the second groove;
a first zone-dividing groove connecting the first groove; and
a second zone-dividing groove connecting the second groove.

9. The food warming plate according to claim 8, wherein the first heating wire and the second heating wire are not connected to each other, an end of the first heating wire adjacent to the second heating wire is extended into the control box through the first zone-dividing groove, an end of the second heating wire adjacent to the first heating wire is extended into the control box through the second zone-dividing groove, and the first heating wire and the second heating wire are configured to form two mutually independent heating zones on the first plate body under control of the control board.

10. The food warming plate according to claim 8, wherein the first heating wire and the second heating wire form different parts of a heating wire, the first heating wire and the second heating wire are connected in the connecting groove, and the first heating wire and the second heating wire are configured to form a single heating zone on the first plate body under control of the control board.

11. The food warming plate according to claim 3, wherein the second plate body comprises:
an edge part received in the control box and formed with a wiring groove, the wiring groove comprising:
a connecting groove connecting the third groove and the fourth groove;
a first zone-dividing groove connecting the third groove; and
a second zone-dividing groove connecting the fourth groove.

12. The food warming plate according to claim 11, wherein the third heating wire and the fourth heating wire are not connected to each other, an end of the third heating wire adjacent to the fourth heating wire is extended into the control box through the first zone-dividing groove, an end of the fourth heating wire adjacent to the third heating wire is extended into the control box through the second zone-dividing groove, and the third heating wire and the fourth heating wire are configured to form two mutually independent heating zones on the second plate body under control of the control board.

13. The food warming plate according to claim 11, wherein the third heating wire and the fourth heating wire form different parts of a heating wire, and the third heating wire and the fourth heating wire are connected in the connecting groove and configured to form a single heating zone on the second plate body under control of the control board.

14. The food warming plate according to claim 2, wherein the first groove and the second groove are both S-shaped and distributed on the back of the first plate body in a zoned manner.

15. The food warming plate according to claim 3, wherein the third groove and the fourth groove are both S-shaped and distributed on the back of the second plate body in a zoned manner.

16. The food warming plate according to claim 8, wherein the connecting groove is arc-shaped.

17. The food warming plate according to claim 1, wherein the backs of the first plate body and the second plate body are formed with a plurality of uniformly distributed first bumps and a plurality of uniformly distributed second bumps, a bottom area of each of the plurality of first bumps is larger than a bottom area of each of the plurality of second bumps; and lower edges of the plurality of first bumps are flush with lower edges of the plurality of second bumps.

18. The food warming plate according to claim 1, wherein both the first plate body and the second plate body are flexible plates, or both the first plate body and the second plate body are silicone plates.
